(19) United States
(12) Patent Application Publication
(10) Pub. No.: US 2022/0411339 A1
(43) Pub. Date: Dec. 29, 2022

(54) METHOD FOR PRODUCING A METAL-CERAMIC SUBSTRATE AND FURNACE

(71) Applicant: Heraeus Deutschland GmbH & Co. KG, Hanau (DE)

(72) Inventors: Andre SCHWÖBEL, Hanau (DE); Richard WACKER, Hanau (DE); Daniel SCHNEE, Hanau (DE); Anton-Zoran MIRIC, Hanau (DE)

(21) Appl. No.: 17/808,919

(22) Filed: Jun. 24, 2022

(30) Foreign Application Priority Data
Jun. 29, 2021 (EP) 21182214.3

(51) Int. Cl. C04B 37/02; C04B 35/10; C04B 35/584; C04B 35/581

(52) U.S. Cl. CPC C04B 37/026; C04B 35/10; C04B 35/584; C04B 35/581; C04B 2237/122; C04B 2237/407

(57) ABSTRACT

The invention relates to a method for producing a metal-ceramic substrate and to a furnace suitable for carrying out the method. With the method, a metal-ceramic substrate with increased thermal and current conductivity can be obtained. The method comprises the steps of providing a stack containing a ceramic body, a metal foil, and a solder material in contact with the ceramic body and the metal foil, the solder material comprising a metal having a melting point of at least 700° C., a metal having a melting point of less than 700° C., and an active metal, and heating the stack, the stack passing through a heating zone for heating.

### CROSS-REFERENCE TO RELATED APPLICATIONS

This application claims priority pursuant to 35 U.S.C. 119(a) to European Patent Application No. 21182214.3, filed Jun. 29, 2021, which application is incorporated herein by reference in its entirety.

### DESCRIPTION

The present invention relates to a method for producing a metal-ceramic substrate and to a furnace suitable for carrying out the method.

Metal-ceramic substrates play an important role in the field of power electronics. They are a crucial element in the construction of electronic components and ensure rapid dissipation of high amounts of heat during the operation of these components. Metal-ceramic substrates usually consist of a ceramic layer and a metal layer which is connected to the ceramic layer.

Several methods are known from the prior art for connecting the metal layer to the ceramic layer. In the so-called direct copper bonding (DCB) method, a copper foil is provided superficially with a copper compound (usually copper oxide) having a lower melting point than copper, by reaction of copper with a reactive gas (usually oxygen). When the copper foil treated in this way is applied to a ceramic body and the composite is heated, the copper compound melts and wets the surface of the ceramic body to form a stable, integral bond between the copper foil and the ceramic body. This method is described, for example, in U.S. Pat. No. 3,744,120 A or DE 2319854 C2.

Despite obvious advantages, the DCB method has two main disadvantages. Firstly, the method must be carried out at relatively high temperatures, specifically somewhat below the melting point of copper. Secondly, the method can be used only for oxide-based ceramics such as aluminum oxide or superficially oxidized aluminum nitride. Therefore, there is a need for an alternative method for producing metal-ceramic substrates under less stringent conditions. In an alternative method, metal foils can be connected to ceramic bodies at temperatures of approximately 650 to 1000° C., a specific solder being used which contains a metal with a melting point of at least 700° C. (usually silver) and an active metal. The role of the active metal is to react with the ceramic material and thus to enable a connection of the ceramic material to the remaining solder to form a reaction layer, while the metal with a melting point of at least 700° C. is used to connect this reaction layer to the metal foil. For example, JP4812985 B2 proposes connecting a copper foil to a ceramic body using a solder which contains 50 to 89 percent by weight silver and also copper, bismuth and an active metal. With this method, it is possible to join the copper foil reliably to the ceramic body. In order to avoid problems associated with migration of silver, it can be advantageous to use silver-free solders to connect metal foils to ceramic bodies. These solders are based, for example, on high-melting metals (in particular copper), low-melting metals (such as bismuth, indium or tin) and active metals (such as titanium). Such a technique is proposed, for example, in DE 102017114893 A1. This technique leads in principle to a new, independent connection class, since the base of the solders used is formed by another metal (copper instead of silver), which leads to changed material properties and results in an adaptation with regard to the other solder constituents and modified joining conditions. The metal-ceramic substrates produced in this way therefore have, in addition to a metal layer and a ceramic layer, a connecting layer which lies between the metal layer and the ceramic layer and contains an active metal.

Due to the steadily increasing demands in the field of power electronics, there is also a need to further improve the thermal and current conductivity of metal-ceramic substrates which are produced using a solder material containing a metal having a melting point of at least 700° C., a metal having a melting point of less than 700° C., and an active metal.

Previous approaches to increasing the thermal and current conductivity of metal-ceramic substrates focused on varying the composition of the connecting layer between the metal layer and the ceramic layer. However, it can be advantageous if the composition of the connecting layer remains unchanged, for several reasons. Thus, for example, a given composition of the connecting layer ideally can fulfill technical requirements other than the thermal and current conductivity, can be easy to produce or even can be more cost-effective. It would therefore be advantageous to improve the thermal and current conductivity of metal-ceramic substrates with a given composition of the connecting layer by suitable method measures.

The object of the present invention is therefore to provide a method with which a metal-ceramic substrate with increased thermal and current conductivity can be obtained using a solder material containing a metal having a melting point of at least 700° C., a metal having a melting point of less than 700° C., and an active metal.

This object is achieved by the method of claim 1. The invention therefore provides a method for producing a metal-ceramic substrate comprising the following steps:

a) providing a stack containing
a1) a ceramic body,
a2) a metal foil, and
a3) a solder material in contact with the ceramic body and the metal foil, the solder material comprising:
   (i) a metal having a melting point of at least 700° C.,
   (ii) a metal having a melting point of less than 700° C., and
   (iii) an active metal, and
      b) heating the stack, the stack passing through a heating zone for heating.

The invention also relates to a furnace suitable for carrying out the method.

In the method according to the invention, a stack is provided first, containing a ceramic body, a metal foil, and a solder material in contact with the ceramic body and the metal foil.

The solder material is therefore preferably located in the stack between the ceramic body and the metal foil. According to a preferred embodiment, the stack contains a ceramic body, a (first) metal foil, a (first) solder material in contact with the ceramic body and the first metal foil, a second metal foil, and a second solder material in contact with the ceramic body and the second metal foil. According to this embodiment, a (first) solder material is preferably located between the ceramic body and the (first) metal foil, and a second solder material is preferably located between the ceramic body and the second metal foil. Furthermore, according to this embodiment, the first solder material preferably corresponds to the second solder material.

The ceramic body therefore preferably has a first surface and a second surface. The metal foil preferably has a first surface. The second metal foil—insofar as it is present—preferably has a first surface. According to a preferred embodiment, the (first) solder material is therefore located in the stack between the first surface of the ceramic body and the first surface of the (first) metal foil. According to a further preferred embodiment, the stack contains a second solder material in contact with the second surface of the ceramic body and the first surface of the second metal foil. According to this embodiment, the (first) solder material is preferably located in the stack between the first surface of the ceramic body and the first surface of the (first) metal foil, and the second solder material is preferably located between the second surface of the ceramic body and the first surface of the second metal foil. According to a further preferred embodiment, in addition to the solder material according to the invention, no further layer is located between the ceramic body and the (first) metal foil. According to yet another embodiment, in addition to the solder material according to the invention, no further layer is located between the ceramic body and the second metal foil, insofar as it is present.

The ceramic of the ceramic body is preferably an insulating ceramic. According to a preferred embodiment, the ceramic is selected from the group consisting of oxide ceramics, nitride ceramics and carbide ceramics. According to a further preferred embodiment, the ceramic is selected from the group consisting of metal oxide ceramics, silicon oxide ceramics, metal nitride ceramics, silicon nitride ceramics, boron nitride ceramics and boron carbide ceramics. According to a particularly preferred embodiment, the ceramic is selected from the group consisting of aluminum nitride ceramics, silicon nitride ceramics and aluminum oxide ceramics (such as zirconia toughened alumina (ZTA) ceramics). The ceramic body preferably has a thickness of 0.05-10 mm, more preferably in the range of 0.1-5 mm, and particularly preferably in the range of 0.15-3 mm.

The metal of the metal foil is preferably selected from the group consisting of copper, aluminum and molybdenum. According to a particularly preferred embodiment, the metal of the metal foil is selected from the group consisting of copper and molybdenum. According to a very particularly preferred embodiment, the metal of the metal foil is copper. The metal foil preferably has a thickness in the range of 0.01-10 mm, more preferably in the range of 0.03-5 mm, and particularly preferably in the range of 0.05-3 mm.

The solder material comprises (i) a metal having a melting point of at least 700° C., (ii) a metal having a melting point of less than 700° C., and (iii) an active metal.

According to a preferred embodiment, (i) the metal having a melting point of at least 700° C., (ii) the metal having a melting point of less than 700° C., and (iii) the active metal are pre sent as a constituent of at least one metal component. Therefore, the solder material preferably comprises at least one metal component which contains (i) the metal having a melting point of at least 700° C., (ii) the metal having a melting point of less than 700° C., and (iii) the active metal. For example, it can be preferred that the solder material comprises: a metal component (i) containing a metal having a melting point of at least 700° C., a metal component (ii) containing a metal having a melting point of less than 700° C., and a metal component (iii) containing an active metal. Furthermore, it can also be preferred that the solder material comprises: a metal component (i) containing a member of the group consisting of (i) a metal having a melting point of at least 700° C., (ii) a metal having a melting point of less than 700° C., and (iii) an active metal, and a metal component (ii) containing members of the group consisting of (i) a metal having a melting point of at least 700° C., (ii) a metal having a melting point of less than 700° C., and (iii) an active metal which are not included in metal component (i). The term metal component is not limited further. In addition to metals and metal alloys, it also covers metal compounds such as intermetallic phases and other compounds such as metal hydrides. According to a preferred embodiment, the metal component is therefore selected from the group consisting of metals, metal alloys and metal compounds.

The solder material comprises (i) a metal having a melting point of at least 700° C. The metal having a melting point of at least 700° C. preferably has a melting point of at least 850° C. and particularly preferably a melting point of at least 1000° C. According to a preferred embodiment, the metal having a melting point of at least 700° C. is selected from the group consisting of copper, nickel, tungsten and molybdenum. According to a particularly preferred embodiment, the metal having a melting point of at least 700° C. is copper. According to a further preferred embodiment, the solder material comprises a metal component (i) which contains a metal having a melting point of at least 700° C. According to a particularly preferred embodiment, the solder material comprises a metal component (i) which contains copper. According to a further preferred embodiment, metal component (i) is copper.

The solder material (ii) comprises a metal having a melting point of less than 700° C. The metal having a melting point of less than 700° C. preferably has a melting point of less than 600° C. and particularly preferably a melting point of less than 550° C. According to a preferred embodiment, the metal having a melting point of less than 700° C. is selected from the group consisting of tin, bismuth, indium, gallium, zinc, antimony and magnesium. According to a particularly preferred embodiment, the metal having a melting point of less than 700° C. is tin. According to a further preferred embodiment, the solder material comprises a metal component (ii) which contains a metal having a melting point of less than 700° C. According to a particularly preferred embodiment, the metal component (ii) is an alloy of a metal having a melting point of less than 700° C. with a further metal. The further metal can be selected, for example, from the group consisting of metals having a melting point of less than 700° C., metals having a melting point of at least 700° C., and active metals. According to a further preferred embodiment, the metal component (ii) containing a metal having a melting point of less than 700° C. is selected from the group consisting of tin, bismuth, indium, gallium, zinc, antimony, magnesium, tin-copper alloys, tin-bismuth alloys, tin-antimony alloys, tin-zinc-bismuth alloys and indium-tin alloys. According to yet another particularly preferred embodiment, the metal component (ii) containing a metal having a melting point of less than 700° C. is selected from the group consisting of tin, tin-copper alloys, tin-bismuth alloys, tin-antimony alloys, tin-zinc-bismuth alloys and indium-tin alloys.

The solder material comprises an active metal. The active metal is preferably a metal which, by chemical reaction, produces a connection between the solder, formed from constituents of the solder material, and the ceramic. According to a preferred embodiment, the active metal is selected from the group consisting of hafnium, titanium, zirconium, niobium, tantalum, vanadium and cerium. According to a more preferred embodiment, the active metal is selected from the group consisting of hafnium, titanium, zirconium, niobium and cerium. According to a particularly preferred embodiment, the active metal is selected from the group consisting of hafnium, titanium and zirconium. According to a very particularly preferred embodiment, the active metal is titanium. According to a further preferred embodiment, the solder material comprises a metal component (iii) which contains an active metal. According to a particularly preferred embodiment, the metal component (iii) is an active metal alloy or an active metal compound, particularly preferably an active metal hydride. The metal component (iii) is preferably selected from the group consisting of titanium hydride, titanium-zirconium-copper alloys, zirconium hydride and hafnium hydride. According to a particularly preferred embodiment, the metal component (iii) is selected from the group consisting of hafnium hydride, titanium hydride and zirconium hydride. According to a very particularly preferred embodiment, the metal component (iii) is titanium hydride.

According to a preferred embodiment, the proportion of the metal with a melting point of at least 700° C. is 50-90 percent by weight, more preferably 55-90 percent by weight, particularly preferably 65-90 percent by weight and very particularly preferably 70-90 percent by weight, relative to the total metal weight of the solder material. According to a further preferred embodiment, the proportion of the metal with a melting point of less than 700° C. is 5-45 percent by weight, more preferably 5-40 percent by weight, particularly preferably 5-30 percent by weight and very particularly preferably 5-25 percent by weight, relative to the total metal weight of the solder material. According to yet another preferred embodiment, the proportion of the active metal is 1-20 percent by weight, more preferably 1-15 percent by weight, particularly preferably 1-12 percent by weight and very particularly preferably 1-10 percent by weight, relative to the total metal weight of the solder material.

The solder material is preferably free of or low in silver. Therefore, the proportion of silver is preferably less than 3.0 percent by weight, particularly preferably less than 1.0 percent by weight and very particularly preferably less than 0.2 percent by weight, relative to the total metal weight of the solder material. The absence of silver or the presence of only small amounts of silver means that migration of silver at the edges of the connecting layer in the finished metal-ceramic substrate can be avoided or reduced. Surprisingly, it has been found that the method according to the invention can also improve the current and thermal conductivity of metal-ceramic substrates with such a reduced silver content. This is surprising in that, due to the replacement of silver as a solder base, such metal-ceramic substrates practically represent an independent connection class which has other material properties, which sometimes requires an adaptation with regard to the other solder constituents and modified joining conditions.

According to a further preferred embodiment, the solder material is low in or free of silicon. Therefore, the proportion of silicon is preferably less than 3.0 percent by weight, particularly preferably less than 1.0 percent by weight and very particularly preferably less than 0.5 percent by weight, relative to the total weight of all metals and semimetals in the solder material.

The solder material is in contact with the ceramic body and the metal foil. Accordingly, the solder material is preferably located between the ceramic body and the metal foil. For example, the solder material can be provided on the ceramic body, and then the metal foil can be applied to the solder material. The solder material is preferably at least one material selected from the group consisting of pastes, foils and deposits which contain a metal with a melting point of at least 700° C., a metal with a melting point of less than 700° C., and an active metal. The solder material can therefore also be formed from two or more materials of different composition. For example, a first material, preferably in direct contact with the ceramic body, can contain a metal component (iii) containing an active metal, and a second material, preferably arranged between the first material and the metal foil, can contain metal component (i) containing a metal having a melting point of at least 700° C. and metal component (ii) containing a metal having a melting point of less than 700° C.

The solder material can be a paste. The paste preferably contains (a) at least one metal component which contains a metal having a melting point of at least 700° C., a metal having a melting point of less than 700° C. and an active metal, and (b) an organic medium.

The organic medium is preferably an organic medium which is typically used in the respective technical field. Preferably, the organic medium contains an organic binder, an organic dispersion medium or a mixture thereof.

The organic binder is preferably removed from the solder material during heating. The organic binder is preferably a thermoplastic or a thermoset. Examples of organic binders include cellulose derivatives (such as ethylcellulose, butylcellulose and cellulose acetates), polyethers (such as polyoxymethylene) and acrylic resins (such as polymethyl methacrylates and polybutylene methacrylates).

The organic dispersion medium is preferably an organic compound which imparts a suitable viscosity to the paste and is expelled during drying of the paste or during heating. The organic dispersion medium can be selected, for example, from aliphatic alcohols, terpene alcohols, alicyclic alcohols, aromatic cyclic carboxylic esters, aliphatic esters, carbitols and aliphatic polyols. Examples of the organic dispersion medium include octanol, decanol, terpineols (for example dihydroterpineol), cyclohexanol, dibutyl phthalate, carbitol, ethyl carbitol, ethylene glycol, butanediol and glycerol.

Moreover, the paste can contain customary additives. Examples of such additives include inorganic binders (such as glass frits), stabilizers, surfactants, dispersants, rheology modifiers, wetting aids, defoamers, fillers and hardeners.

According to a preferred embodiment, the proportion of the at least one metal component which contains a metal with a melting point of at least 700° C., a metal having a melting point of less than 700° C. and an active metal is 20-95 percent by weight, more preferably 30-95 percent by weight and particularly preferably 75-95 percent by weight, relative to the total weight of the paste. According to a further preferred embodiment, the proportion of the organic medium is 5-80 percent by weight, more preferably 5-70 percent by weight and particularly preferably 5-25 percent by weight, relative to the total weight of the paste.

According to a further preferred embodiment, the ratio of the total weight of the (a) at least one metal component which contains a metal having a melting point of at least 700° C., a metal having a melting point of less than 700° C. and an active metal to the weight of the (b) organic medium is at least 5:1, particularly preferably at least 7:1 and very particularly preferably at least 8:1. According to a further preferred embodiment, the ratio of the total weight of the (a) at least one metal component which contains a metal having a melting point of at least 700° C., a metal having a melting point of less than 700° C. and an active metal to the weight of the (b) organic medium is in the range of 1:1 to 20:1, particularly preferably in the range of 2:1 to 20:1 and very particularly preferably in the range of 5:1 to 15:1.

To provide the stack, the paste is preferably applied to the surface of the ceramic body. The paste can be applied, for example, by a dispersing method or a printing method. Suitable printing methods are, for example, screen printing methods, inkjet printing methods and offset printing methods. Preferably, the paste is applied to the surface of the ceramic body by a screen printing method.

After paste application, the paste can be pre-dried if necessary. The pre-drying can take place at room temperature or at elevated temperature. The conditions for the pre-drying can vary depending on the organic medium contained in the paste. The pre-drying temperature can, for example, be in the range of 50-180° C. and is preferably in the range of 80-150° C. The pre-drying is usually carried out for a period of 2 min-2 h and preferably for a period of 5 min-1 h.

The surface of the metal foil can then be applied to the paste, which is pre-dried if required, to obtain a stack.

The solder material can also be a foil.

The foil comprises (i) a metal having a melting point of at least 700° C., (ii) a metal having a melting point of less than 700° C., and (iii) an active metal. In addition, the foil can comprise further constituents, such as, for example, a suitable binder.

The foil can be obtained, for example, by homogenizing at least one metal component which contains a metal having a melting point of at least 700° C., a metal having a melting point of less than 700° C. and an active metal, and optionally further constituents and heating them to a temperature which is below the melting temperature of the metal having a melting point of at least 700° C., of the metal having a melting point of less than 700° C. and of the active metal, but which is sufficient to form a bond between the metals. This temperature can be at least 200° C., for example.

Alternatively, the foil can be obtained, for example, by mixing at least one metal component which contains a metal having a melting point of at least 700° C., a metal having a melting point of less than 700° C. and an active metal, and a binder, and forming and heating the mixture to form a green body. During heating, the binder can cure and form a matrix in which the metals are distributed.

To provide the stack, the foil can be placed on the ceramic, for example. The surface of the metal foil can then be applied to the foil located on the ceramic to obtain a stack.

According to a further embodiment, the solder material can be a deposit. The deposit of the solder material can be produced for example by electroplating or chemical vapor deposition. Preferably, the deposit of the solder material is produced on the ceramic body. The metal foil can then be applied to the solder material deposited on the ceramic to obtain a stack.

After the stack is provided, the stack is heated, the stack passing through a heating zone for heating.

The heating of the stack preferably takes place to obtain a metal-ceramic substrate. According to a preferred embodiment, the heating takes place wherein a metal-ceramic substrate is obtained forming an integral bond between the ceramic body and the metal foil via the solder material. The integral bond is preferably formed in that the active metal enters into a connection with the ceramic body, and the metal having a melting point of at least 700° C., the metal having a melting point of less than 700° C. and the metal of the metal foil are connected to form an alloy. During the subsequent solidification, an integral bond is then formed between the ceramic body and the metal foil via the solder material.

Therefore, conditions preferably prevail in the heating zone which enable the formation of an integral bond between the ceramic and the metal foil via the solder material. The temperature and atmosphere present in the heating zone are preferably adjustable. The heating zone preferably has an inlet and an outlet. When passing through the heating zone, the stack preferably enters the heating zone through the inlet and exits the heating zone through the outlet. Preferably, the inlet is different from the outlet.

According to a preferred embodiment, the stack and the heating zone are arranged such that the position of the stack relative to the position of the heating zone can be changed in order to allow the stack to pass through the heating zone. Preferably, the distance between the stack and the heating zone decreases before the passage through the heating zone, reaches a minimum during passage through the heating zone and increases after passage through the heating zone. According to a preferred embodiment, a relative movement of the stack and the heating zone takes place for this purpose, wherein the stack and the heating zone initially execute a relative movement toward one another and after passing through execute a relative movement away from one another. For this purpose, the stack may be arranged in a stationary manner and the heating zone may be arranged so as to be mobile, the stack may be arranged so as to be mobile and the heating zone may be arranged in a stationary manner, or the stack and heating zone may be arranged so as to be mobile.

When passing through the heating zone, the stack experiences a temperature charging. The stack on passing through is accordingly at a distance from the heating zone which ensures a temperature input necessary for the formation of an integral bond between the ceramic body and the metal foil.

Surprisingly, it has been found that a metal-ceramic substrate with improved thermal and current conductivity can be obtained when the stack passes through a heating zone for heating.

Without wishing to be bound by theory, this could be due to the fact that a targeted control of the energy input can be achieved by passing through the heating zone. If the stack passes through the heating zone, the temperature in the heating zone and the speed at which the stack passes through the heating zone can be ideally matched to the structure and the dimensions of the stack, so that only the energy input necessary for the formation of an integral bond between the ceramic body and the metal foil takes place. This prevents an excessive energy input, which regularly leads to an increased diffusion of metals with a melting point of at least 700° C. and metals with a melting point of less than 700° C. into the metal foil, which can ultimately cause a decrease in the current and thermal conductivity in the finished metal-ceramic substrate. Furthermore, a uniform distribution of the temperature and of the gases (for example inert gases) contained in the heating zone is ensured on passing through the heating zone. As a result, when a plurality of metal-ceramic substrates are produced using the method according to the invention, a lower variation of the quality of the produced metal-ceramic substrates occurs in comparison to conventional methods (for example using a batch furnace). In this respect, heating of the stack by passing through a heating zone has proven to be advantageous over stationary heating (for example in a batch furnace).

According to a particularly preferred embodiment, the stack is heated in a furnace, preferably in a continuous furnace.

The furnace preferably has a heating zone and a carrier system. The stack is preferably arranged on the carrier system. Preferably, the heating zone and the carrier system are designed such that the position of the stack relative to the position of the heating zone can be changed in order to allow heating of the stack while it passes through the heating zone. Preferably, the heating zone and the carrier system are therefore designed in such a way that the distance between the stack and the heating zone can be reduced until the distance is at a minimum during passage through the heating zone, and the distance can be increased after passage through the heating zone. According to a preferred embodiment, the heating zone and the carrier system are therefore designed for a relative movement, so that the stack and the heating zone initially execute a relative movement toward one another and after passing execute a relative movement away from one another.

The furnace can preferably be a continuous furnace. Accordingly, according to a preferred embodiment, the stack is heated in a continuous furnace, wherein the stack passes through the heating zone of the continuous furnace during heating. A continuous furnace preferably has at least one heating zone and, as a carrier system, a revolving conveyor chain, a conveyor roller system or a sliding system, for example, on which a workpiece can be conveyed through the heating zone. There can be further zones in the continuous furnace before the heating zone and after the heating zone in the conveying direction. For instance, it can be advantageous for a cooling zone to be located after the heating zone in the continuous furnace. In addition, it can be advantageous for gas inlets and gas outlets, through which the zones can be supplied with gas (for example an inert gas such as nitrogen), to be located in the heating zone and any further zones which may be present. Such continuous furnaces are well-known from the prior art (see for example DE 4008979 C1 and EP 0085914 A2).

According to a preferred embodiment of the method according to the invention, the stack is first applied to a carrier. The carrier can be made of silicon carbide, for example. The silicon carbide carrier can be provided with a further support, for example a graphite foil.

The stack, preferably arranged on a carrier, is subsequently preferably placed on a carrier system, for example a conveyor belt. The conveyor belt can be, for example, a conveyor chain, a conveyor roller system or a sliding system of a continuous furnace.

According to a preferred embodiment, the stack passes through the heating zone on the carrier system. The carrier system is preferably driven, for example by means of rolls.

During heating, the stack is heated to a peak temperature. The peak temperature is not limited further and is preferably less than or equal to the melting point of the metal having a melting point of at least 700° C. and lower than the melting point of the metal of the metal foil. According to a preferred embodiment, the peak temperature is at least 10° C. and particularly preferably at least 50° C. below the melting point of the metal of the metal foil. According to a further preferred embodiment, the peak temperature is at least 700° C. The peak temperature is preferably in the range of 700-1100° C., particularly preferably in the range of 750-1050° C., and very particularly preferably in the range of 800-1000° C. As used herein, the peak temperature refers to the temperature measured at the stack by means of a thermocouple. The peak temperature is the maximum temperature measured at the stack. In order to prevent disadvantageous effects such as excessive contraction or oozing of the molten metal due to excessive fluidity of the molten metal, the person skilled in the art will seek to avoid excessively high peak temperatures.

During heating, the stack undergoes a temperature input for a heating duration. The heating duration herein preferably refers to the time period during which the stack is exposed to a temperature of at least 200° C. during heating. The heating duration is not limited further as long as it is sufficient to ensure wetting of the surfaces to be connected and their availability for integral bonding. According to a preferred embodiment, the heating duration is at least 2 min and particularly preferably at least 10 min. According to a further preferred embodiment, the heating duration is no more than 5 h, particularly preferably no more than 2 h, and very particularly preferably no more than 90 min. The heating duration is preferably in the range of 2 min-5 h, particularly preferably in the range of 2 min-2 h, and very particularly preferably in the range of 10-90 min.

During heating, the stack undergoes a temperature input for a high-temperature heating duration. The high-temperature heating duration herein preferably refers to the time period during which the stack is exposed to a temperature corresponding at least to the peak temperature −250° C. during heating. With an exemplary peak temperature of 900° C., the high-temperature heating duration therefore corresponds to the time period during which the stack is exposed at least to a temperature of 650° C. during heating. According to a preferred embodiment, the high-temperature heating duration is no more than 60 min, more preferably no more than 50 min, particularly preferably no more than 45 min, and very particularly preferably no more than 40 min. The high-temperature heating duration is preferably in the range of 2-60 min, more preferably in the range of 3-50 min, particularly preferably in the range of 5 to 45 min, and very particularly preferably in the range of 10-40 min.

During heating, the stack undergoes a temperature input for a peak-temperature heating duration. The peak-temperature heating duration herein preferably refers to the time period during which the stack is exposed to a temperature corresponding at least to the peak temperature −50° C. during heating. With an exemplary peak temperature of 900° C., the peak-temperature heating duration therefore corresponds to the time period during which the stack is exposed at least to a temperature of 850° C. during heating. According to a preferred embodiment, the peak-temperature heating duration is no more than 30 min, more preferably no more than 25 min, particularly preferably no more than 20 min, and very particularly preferably no more than 15 min. The peak-temperature heating duration is preferably in the range of 1-30 min, more preferably in the range of 1-25 min, particularly preferably in the range of 2-20 min, and very particularly preferably in the range of 3-15 min.

According to a further particularly preferred embodiment, the high-temperature heating duration is in the range of 10-40 min, and the peak-temperature heating duration is in the range of 3-15 min.

Surprisingly, it has been found that a short high-temperature heating duration and a short peak-temperature heating duration have an advantageous effect on the current and thermal conductivity of the finished metal-ceramic substrate.

According to a further preferred embodiment, the ratio of peak-temperature heating duration (in min) to heating duration (in min) is no more than 1:2. The ratio of peak-temperature heating duration (in min) to heating duration (in min) is preferably in the range of 1:2 to 1:15, more preferably in the range of 1:2 to 1:10, particularly preferably in the range of 1:2 to 1:7 and very particularly preferably in the range of 1:3 to 1:6. Surprisingly, it has been found that the thermal and current conductivity of the metal-ceramic substrates can be further improved with a ratio of peak-temperature heating duration (in min) to heating duration (in min) within the specified range.

When the stack is heated, a temperature input takes place for a heating-up duration. The heating-up duration here preferably denotes the time period which the stack requires in order to reach the peak temperature starting from a temperature of 100° C. According to a preferred embodiment, the heating-up duration is no more than 60 min, particularly preferably no more than 45 min, and very particularly preferably no more than 30 min. The heating-up duration is preferably in the range of 1-60 min, more preferably in the range of 5-45 min, and particularly preferably in the range of 10-30 min.

A non-oxidizing atmosphere is preferably present in the heating zone. The non-oxidizing atmosphere is preferably an inert gas atmosphere. Preferably, a nitrogen atmosphere, a helium atmosphere or an argon atmosphere is present in the heating zone. According to a particularly preferred embodiment, a nitrogen atmosphere is present in the heating zone. Preferably, the proportion of a reactive gas, in particular oxygen, in the non-oxidizing atmosphere is less than 1000 ppm, more preferably less than 500 ppm, and particularly preferably less than 40 ppm.

When the stack is heated, an integral bond is formed between the ceramic body and the metal foil via the solder material to obtain a metal-ceramic substrate. The metal-ceramic substrate can be subjected to further treatment steps if necessary. For example, the metal-ceramic substrate, preferably the exposed surface of the metal foil of the metal-ceramic substrate, can be polished. Preferably, the surface of the metal foil of the metal-ceramic substrate is polished physically or chemically. Further, the metal-ceramic substrate can be structured. For example, the metal-ceramic substrate can be provided with conductor tracks. The conductor tracks are preferably produced by etching.

The metal-ceramic substrate produced according to the invention can be used in particular for applications in electronics, especially for the field of power electronics.

According to a preferred embodiment, the invention also relates to a furnace as described above with respect to the method. The furnace preferably has

(1) a heating zone,
(2) a carrier system, and
(3) a stack arranged on the carrier system and containing
a1) a ceramic body,
a2) a metal foil, and
a3) a solder material in contact with the ceramic body and the metal foil, the solder material comprising:
   (i) a metal having a melting point of at least 700° C.,
   (ii) a metal having a melting point of less than 700° C., and
   (iii) an active metal,

wherein the heating zone and the carrier system are designed such that the position of the stack relative to the position of the heating zone can be changed in order to allow heating of the stack while it passes through the heating zone.

According to a particularly preferred embodiment, the furnace is a continuous furnace. The carrier system is preferably designed as a revolving conveyor chain, as a conveyor roller system or as a sliding system. According to a preferred embodiment, the stack is arranged on the conveyor chain and can be moved through the heating zone on the conveyor chain.

The furnace is particularly suitable for carrying out the method according to the invention.

In the examples, metal-ceramic substrates were produced under various conditions. In each case, a stack containing a ceramic body, a metal foil, and a solder material in contact with the ceramic body and the metal foil was provided and then heated. The solder material was a standard paste containing copper, tin and titanium as metals. The current and thermal conductivity were then evaluated qualitatively. Comparable results can also be achieved with other material combinations.

For the production of metal-ceramic substrates, 31.67 percent by weight of SnCu0.7 powder, 7.24 percent by weight of titanium hydride and 9.50 percent by weight of an organic vehicle containing Texanol were first mixed at 35 Hz for 20 minutes in a standing mixer. Then, 51.59 percent by weight of copper powder were added in increments. The mixture thus produced was stirred at high speed until a homogeneous paste was obtained.

With the paste produced in this way, ceramic bodies were joined on their opposite surfaces to copper foils on both sides. For this purpose, ceramic bodies having the dimensions 177.8×139.7×0.32 mm (obtained from Toshiba Materials) and identical front and rear properties were used in each case. The paste was screen-printed onto the rear side of such a ceramic body in a region of the dimensions 137×175 mm² by means of a 165 mesh screen and pre-dried at 125° C. for 15 minutes. The paste thickness after pre-drying was 35+/−5 μm. The arrangement thus produced was then turned around, and the paste likewise printed onto the front side of the ceramic body and pre-dried. The ceramic provided with paste on both sides was then provided on both sides with copper foil made of oxygen-free, highly conductive copper with a purity of 99.99% and dimensions of 174×137×0.3 mm to obtain a stack with the following structure: copper foil-pre-dried paste-ceramic-pre-dried paste-copper foil.

The stack was then heated in a continuous furnace. To this end, a silicon carbide plate, to which a graphite foil was applied, was first placed onto the conveyor chain of a continuous furnace. The stack was placed on the graphite foil and was then covered with a further graphite foil and weighted with a further silicon carbide plate (weight=600 g). The structure was subsequently conveyed through the heating zone of a continuous furnace on the conveyor chain. The peak temperature (measured at the stack with a type K thermocouple manufactured by Temperatur Messelemente Hettstedt GmbH) was 935° C. The metal-ceramic substrate thus obtained was then cooled to room temperature to obtain a metal-ceramic substrate which contained a ceramic layer connected on both sides to a copper layer via a connecting layer.

Example 2 was carried out analogously to example 1, but the peak temperature (measured at the stack using a type K thermocouple manufactured by Temperatur Messelemente Hettstedt GmbH) was 910° C.

The comparative example was carried out analogously to example 1, but the stack was heated in a batch furnace instead of in a continuous furnace. To this end, the stack was placed in the batch furnace and heated. The peak temperature (measured at the stack with a type K thermocouple manufactured by Temperatur Messelemente Hettstedt GmbH) was 910° C.

The thermal and current conductivity of the metal-ceramic substrates obtained in the examples was then evaluated as follows:

| Example | Conductivity |
|---|---|
| Example 1 | high |
| Example 2 | high |
| Comparative example | low |

It was found that the conductivity of metal-ceramic substrates can be significantly improved when the method according to the invention is used. Without wishing to be bound by theory, this could be due to the fact that, owing to the only temporary passage through the heating zone, in contrast to the conventional method, the method according to the invention enables a precisely targeted energy input which, on the one hand, is high enough to ensure the formation of an integral bond, but on the other hand prevents deep penetration of metals from the solder material into the metal foil. It was thus possible to show that the metal having a melting point of less than 700° C. (tin, in the examples) penetrates less deeply into the metal foil in the method according to the invention than is the case with conventional methods. For the metal-ceramic substrates obtained in examples 1 and 2, a depth profile analysis showed a diffusion of tin into the copper foil reduced by more than 30% in comparison with the metal-ceramic substrate of the comparative example. Consequently, the conductivity of the finished metal-ceramic substrate is less impaired in examples 1 and 2.

1. A method for producing a metal-ceramic substrate comprising the steps of:
a) providing a stack containing
a1) a ceramic body,
a2) a metal foil, and
a3) a solder material in contact with the ceramic body and the metal foil, the solder material comprising:
(i) a metal having a melting point of at least 700° C.,
(ii) a metal having a melting point of less than 700° C., and
(iii) an active metal, and
b) heating the stack, the stack passing through a heating zone for heating.

2. The method according to claim 1, wherein the ceramic of the ceramic body is selected from the group consisting of aluminum nitride ceramics, silicon nitride ceramics and aluminum oxide ceramics.

3. The method according to claim 1, wherein the metal of the metal foil is copper.

4. The method according to claim 1, wherein the metal having a melting point of at least 700° C. is copper.

5. The method according to claim 1, wherein the metal having a melting point of less than 700° C. is selected from the group consisting of tin, bismuth, indium, gallium, zinc, antimony and magnesium.

6. The method according to claim 1, wherein the active metal is selected from the group consisting of hafnium, titanium, zirconium, niobium, tantalum, vanadium and cerium.

7. The method according to claim 1, wherein the proportion of silver is less than 3.0 percent by weight, relative to the total metal weight of the solder material.

8. The method according to claim 1, wherein a non-oxidizing atmosphere is present in the heating zone.

9. The method according to claim 1, wherein a nitrogen atmosphere is present in the heating zone.

10. The method according to claim 1, wherein the peak-temperature heating duration is no more than 30 min, wherein the peak-temperature heating duration refers to the time duration during which the stack is exposed to a temperature corresponding at least to the peak temperature −50° C.

11. The method according to claim 1, wherein the heating-up duration is no more than 60 min, wherein the heating-up duration denotes the time period which the stack requires in order to reach the peak temperature starting from a temperature of 100° C.

12. A furnace having at least
(1) a heating zone,
(2) a carrier system, and
(3) a stack arranged on the carrier system and containing
a1) a ceramic body,
a2) a metal foil, and
a3) a solder material in contact with the ceramic body and the metal foil, the solder material comprising:
(i) a metal having a melting point of at least 700° C.,
(ii) a metal having a melting point of less than 700° C., and
(iii) an active metal,
wherein the heating zone and the carrier system are designed such that the position of the stack relative to the position of the heating zone can be changed in order to allow heating of the stack while it passes through the heating zone.
